(19) United States
(12) Patent Application Publication
(10) Pub. No.: US 2019/0100670 A1
(43) Pub. Date: Apr. 4, 2019

(54) CONDUCTIVE INK

(71) Applicant: TAIFLEX Scientific Co., Ltd., Kaohsiung (TW)

(72) Inventors: Chiu-Feng Chen, Kaohsiung (TW); Chung-Sung Tan, Kaohsiung (TW); Wen-Hsin Shen, Kaohsiung (TW); Ya-Fen Yang, Kaohsiung (TW); Chun-Yuan Huang, Kaohsiung (TW); Wan-Tai Tu, Kaohsiung (TW)

(73) Assignee: TAIFLEX Scientific Co., Ltd., Kaohsiung (TW)

(21) Appl. No.: 15/828,438

(22) Filed: Dec. 1, 2017

(30) Foreign Application Priority Data
Sep. 29, 2017 (TW) 106133601

(51) Int. Cl. C09D 11/52; C09D 11/38; C08K 5/098; C08K 5/00; C08K 3/08

(52) U.S. Cl. CPC C09D 11/52; C09D 11/38; C08K 2201/001; C08K 5/0091; C08K 3/08; C08K 5/098

(57) ABSTRACT

A conductive ink is provided. The conductive ink includes a precursor, a reducing agent, and a protective agent, and the precursor includes copper isostearate (Cu(C₁₈H₃₆O₂)₂), wherein based on the total weight of the conductive ink, the content of the precursor is 40 wt % to 75 wt %, the content of the reducing agent is 20 wt % to 32 wt %, and the content of the protective agent is 5 wt % to 40 wt %.

### CROSS-REFERENCE TO RELATED APPLICATION

This application claims the priority benefit of Taiwan application serial no. 106133601, filed on Sep. 29, 2017. The entirety of the above-mentioned patent application is hereby incorporated by reference herein and made a part of this specification.

### BACKGROUND OF THE INVENTION

### Field of the Invention

The invention relates to a conductive ink, and more particularly, to a copper-containing conductive ink.

### Description of Related Art

To simplify the numerous and complex steps of preparing a conductive circuit via a lithography process, directly printing a conductive ink on a substrate to form a conductive circuit has become a feasible method. In general, the conductive ink with metal as the main component is divided into two types: metal nanoparticle type and organic metal type. In a known conductive ink technique, the resulting conductive layer has a certain thickness, and it is difficult to form a conductive layer having a smaller thickness (such as 1 μm or less). Therefore, the current development trend of a compact and lightweight product is not met.

Based on the above, the development of a conductive ink with metal as the main component that can form a conductive layer having a smaller thickness (such as 1 μm or less) is an important topic requiring research.

### SUMMARY OF THE INVENTION

The invention provides a conductive ink containing nano copper powders that can form a conductive layer having a smaller thickness (such as 1 μm or less).

The conductive ink of the invention includes a precursor, a reducing agent, and a protective agent, and the precursor includes copper isostearate (Cu(C₁₈H₃₆O₂)₂), wherein based on the total weight of the conductive ink, the content of the precursor is 40 wt % to 75 wt %, the content of the reducing agent is 20 wt % to 32 wt %, and the content of the protective agent is 5 wt % to 40 wt %.

In an embodiment of the invention, the conductive ink further includes a solvent.

In an embodiment of the invention, the solvent includes water, toluene, cyclohexane, n-heptane, isooctane, methanol (MeOH), ethanol (EtOH), ethylene glycol (EG), diethylene glycol, or supercritical carbon dioxide.

In an embodiment of the invention, the reducing agent includes Vitamin C, sodium borohydride (NaBH₄), hydrazine (N₂H₄), hydrogen peroxide (H₂O₂), hydrogen (H₂), sodium hypophosphite (NaH₂PO₂), sodium citrate (Na₃C₆H₅O₇), potassium sodium tartrate (NaKC₄H₄O₆), an amine compound, or an aldehyde compound.

In an embodiment of the invention, the amine compound includes dimethylformamide (DMF).

In an embodiment of the invention, the aldehyde compound includes glucose.

In an embodiment of the invention, the protective agent includes polyacrylic acid (PAA), polyvinyl alcohol (PVA), polyvinylpyrrolidone (PVP), gelatin, sodium dodecyl sulfate (SDS), polyethylene glycol octylphenyl ether (TX-100), cetyltrimethylammonium bromide (CTAB), sodium dioctyl sulfosuccinate (AOT), bis(2-ethylhexyl)phosphoric acid (HDEHP), oleic acid, or dodecaneamine.

In an embodiment of the invention, the precursor is formed by the reduction reaction of isostearic acid (C₁₈H₃₆O₂) and a copper-containing compound.

In an embodiment of the invention, the copper-containing compound includes CuSO₄, CuCl₂, Cu(AOT)₂, Cu(NO₃)₂, Cu(OH)₂, or Cu(acac)₂.

Based on the above, the conductive ink of the invention is a nano copper ink with copper isostearate as the precursor and containing a reducing agent and a protective agent, wherein the copper isostearate is formed by the reduction reaction of isostearic acid and a copper-containing compound. A conductive layer having a smaller thickness (such as 1 μm or less) can be formed by the conductive ink of the invention.

In order to make the aforementioned features and advantages of the invention more comprehensible, embodiments are described in detail below.

### DESCRIPTION OF THE EMBODIMENTS

In the present specification, a range represented by “a numerical value to another numerical value” is a schematic representation for avoiding listing all of the numerical values in the range in the specification. Therefore, the recitation of a specific numerical range covers any numerical value in the numerical range and a smaller numerical range defined by any numerical value in the numerical range, as is the case with the any numerical value and the smaller numerical range stated explicitly in the specification.

In the following, the embodiments of the invention are described in detail. However, these embodiments are exemplary, and the invention is not limited thereto.

The invention provides a conductive ink including a precursor, a reducing agent, a protective agent, and a solvent. Hereinafter, the various components above are described in detail.

### <Precursor>

In the present embodiment, the precursor is, for instance, copper isostearate (Cu(C₁₈H₃₆O₂)₂) and can be represented by the following chemical structure formula:

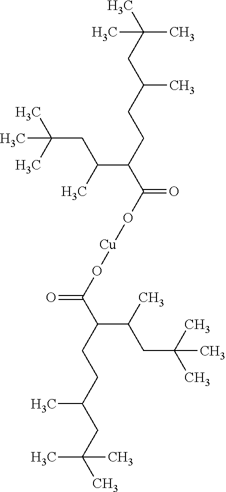

The copper isostearate is, for instance, formed by the reduction reaction of isostearic acid (C₁₈H₃₆O₂) and a copper-containing compound, wherein the copper-containing compound can include CuSO₄, CuCl₂, Cu(AOT)₂, Cu(NO₃)₂, Cu(OH)₂, or Cu(acac)₂, but the invention is not limited thereto. More specifically, the copper isostearate is, for instance, formed by reacting isostearic acid and a copper-containing compound in n-heptane and then removing water and n-heptane via rotary concentration after the reaction. Based on the total weight of the conductive ink, the content of the precursor is, for instance, 40 wt % to 75 wt %.

### <Reducing Agent>

In the present embodiment, the reducing agent can include Vitamin C, sodium borohydride (NaBH₄), hydrazine (N₂H₄), hydrogen peroxide (H₂O₂), hydrogen (H₂), sodium hypophosphite (NaH₂PO₂), sodium citrate (Na₃C₆H₅O₇), potassium sodium tartrate (NaKC₄H₄O₆), an amine compound, or an aldehyde compound, wherein the amine compound can include dimethylformamide (DMF), and the aldehyde compound can include glucose, but the invention is not limited thereto. Based on the total weight of the conductive ink, the content of the reducing agent is, for instance, 20 wt % to 32 wt %.

### <Protective Agent>

In the present embodiment, the protective agent can include polyacrylic acid (PAA), polyvinyl alcohol (PVA), polyvinylpyrrolidone (PVP), gelatin, sodium dodecyl sulfate (SDS), polyethylene glycol octylphenyl ether (TX-100), cetyltrimethylammonium bromide (CTAB), sodium dioctyl sulfosuccinate (AOT), bis(2-ethylhexyl)phosphoric acid (HDEHP), oleic acid, or dodecaneamine. The chemical structure formula of each protective agent example above is shown below:

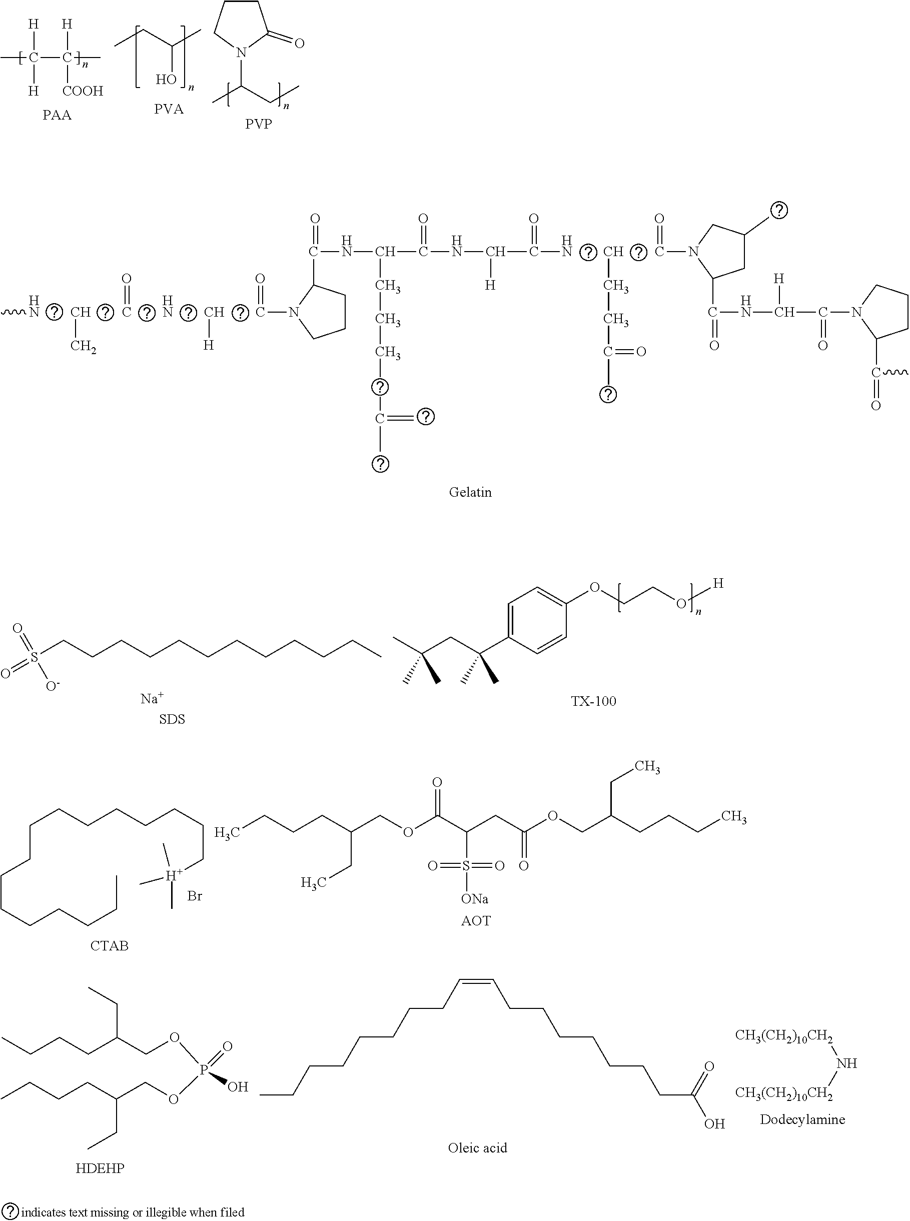

Based on the total weight of the conductive ink, the content of the protective agent is, for instance, 5 wt % to 40 wt %.

### <Solvent>

In the present embodiment, the solvent can include water, toluene, cyclohexane, n-heptane, isooctane, methanol (MeOH), ethanol (EtOH), ethylene glycol (EG), diethylene glycol, supercritical carbon dioxide, or anhydrous alcohol. The solvent is mainly used to dissolve the aforementioned precursor, reducing agent, and protective agent. For instance, in the manufacturing process of the conductive ink of the invention, copper isostearate and polyvinylpyrrolidone (PVP) can be dissolved in anhydrous alcohol, and Vitamin C can be dissolved in methanol and ethylene glycol.

The conductive ink of the invention can be coated on a substrate, and the solvent, reducing agent, and protective agent can be removed by a heat treatment (heating and sintering) to form a very thin conductive layer (a thickness of, for instance, 1 μm or less). A suitable substrate material is, for instance, polyimide (PI) or glass, but the invention is not limited thereto, and the conductive ink of the invention can also be coated on other substrates on which a conductive layer can be formed.

In the following, the conductive ink of the embodiments is described in detail via an experimental example. However, the following experimental example is not intended to limit the invention.

### Experimental Example

To prove that the conductive ink provided in the invention can form a very thin conductive layer, the following experimental example is provided.

The conductive ink of the invention can mainly contain a precursor, a reducing agent, a protective agent, and a solvent. Based on the total weight of the conductive ink, the content of the precursor is 40 wt % to 75 wt %, the content of the reducing agent is 20 wt % to 32 wt %, and the content of the protective agent is 5 wt % to 40 wt %, for example. That is, in the preparation process of the conductive ink of the invention, if 1 g of the precursor is added, then 0.28 g to 0.5 g of the reducing agent and 0.1 g to 1.0 g of the protective agent can be added.

First, isostearic acid and copper hydroxide were reacted in n-heptane, and then water and the n-heptane were removed after the reaction via rotary concentration to form copper isostearate. Next, copper isostearate and PVP were dissolved in anhydrous alcohol, and Vitamin C was dissolved in methanol and ethylene glycol, and then the components were mixed to form a nano copper suspension solution. The synthesis process of nano copper can be performed in two ways, the first is synthesizing nano copper at room temperature and normal pressure, and the second is synthesizing nano copper in a carbon dioxide expansion liquid. The reaction conditions of the two synthesis methods and each parameter of the resulting nano copper are shown in Table 1 and Table 2 below: Table 1 shows nano copper synthesized under the reaction condition of room temperature, with an average particle size of 200 nm to 300 nm; and Table 2 shows nano copper synthesized in a carbon dioxide expansion liquid, with an average particle size of 150 run to 260 nm.

TABLE 1

| Precursor | Solvent | | | Reducing | | | Copper | Standard | |
|---|---|---|---|---|---|---|---|---|---|
| Copper | Anhydrous | | Ethylene | agent | Protective | Reaction | average | deviation of | |
| isostearate | alcohol | Methanol | glycol | Vitamin | agent | temperature | particle size | copper particle | Conversion rate |
| (g) | (mL) | (mL) | (mL) | C (g) | PVP (g) | (° C.) | (nm) | size | (%) |
| 1 | 10 | 10 | 10 | 0.5 | 0 | 30 | Significant | Significant | 94.49 |
| | | | | | | | agglutination | agglutination | |
| | | | | | 0.1 | | 264 | 98 | 86.58 |
| | | | | | 0.2 | | 255 | 124 | 89.25 |
| | | | | | 0.3 | | 232 | 103 | 84.14 |
| | | | | | 0.4 | | 209 | 69 | 84.65 |
| | | | | | 0.45 | | 207 | 63 | 81.51 |
| | | | | | 0.5 | | 205 | 56 | 81.54 |
| | | | | | 0.55 | | 209 | 63 | 78.06 |
| | | | | | 0.6 | | 233 | 73 | 82.51 |
| | | | | | 0.7 | | 221 | 71 | 86.29 |
| | | | | | 0.8 | | 242 | 88 | 83.81 |
| | | | | | 0.9 | | 238 | 123 | 83.03 |
| | | | | | 1.0 | | 230 | 87 | 83.82 |

TABLE 2

| | | | | | | | | | | Standard | |
|---|---|---|---|---|---|---|---|---|---|---|---|
| Precursor | Solvent | | | Reducing | Protective | | | Volume | Copper | deviation | |
| Copper | Anhydrous | | Ethylene | agent | agent | Reaction | CO₂ | expansion | average | of copper | |
| isostearate | alcohol | Methanol | glycol | Vitamin | PVP | temperature | pressure | rate | particle | particle | Conversion |
| (g) | (mL) | (mL) | (mL) | C (g) | (g) | (° C.) | (psi) | (ΔV/V)/% | size (nm) | size | rate (%) |
| 1 | 10 | 10 | 10 | 0.5 | 0.5 | 30 | 0 | 0 | 205 | 56 | 81.54 |
| | | | | | | | 500 | 16.67 | 255 | 95 | 96.94 |
| | | | | | | | 600 | 26.67 | 210 | 71 | 97.2 |
| | | | | | | | 700 | 33.33 | 201 | 83 | 99.16 |
| | | | | | | | 800 | 40 | 186 | 59 | 99.5 |
| | | | | | | | 900 | 50 | 183 | 77 | 99.4 |
| | | | | | | | 1000 | 83.33 | 176 | 64 | 99.6 |

Next, the nano copper suspension solution was centrifuged at 6000 rpm for half an hour to make nano copper precipitate at the bottom of the centrifuge tube. After the solvent in the upper layer in which impurities were dissolved was discarded, the nano copper was placed in a vacuum oven for 1 hour to obtain nano copper chunks. After weighing, anhydrous alcohol and tert-butanol in a volume ratio of 1:2 were added to form 20 wt % of copper ink. The preparation of copper ink was performed by mixing ethylene glycol and anhydrous alcohol at different ratios, and the resistivity thereof after spin coating (1500 rpm) and 250° C. sintering is shown in Table 3 (four-point probe detection). If the ethylene glycol ratio was higher, then the film after spin coating was not continuous, wherein the resistivity of anhydrous alcohol and ethylene glycol (3:2) was lowest. The resulting copper ink was sintered at different temperatures (200° C., 250° C., 300° C., 350° C., and 400° C.) after spin coating, wherein conductivity started to occur at 250° C., and conductivity was best at 400° C.

TABLE 3

| | Sintering | | | |
|---|---|---|---|---|
| | tempera- | Sheet | Film | |
| | ture | resistance | thickness | Resistivity |
| Ink recipe | (° C.) | (Ω/□) | (nm) | (Ω · m) |
| 20 wt % Cu and | 250 | N/A | | |
| ethylene glycol | | | | |
| 20 wt % Cu, anhydrous | | N/A | | |
| alcohol, and ethylene | | | | |
| glycol (1:4) | | | | |
| 20 wt % Cu, anhydrous | | 61 | 355 | 2.2 × 10⁻⁵ |
| alcohol, and ethylene | | | | |
| glycol (2:3) | | | | |
| 20 wt % Cu, anhydrous | | 25 | 316 | 7.9 × 10⁻⁶ |
| alcohol, and ethylene | | | | |
| glycol (3:2) | | | | |
| 20 wt % Cu, anhydrous | | 111 | 249 | 2.8 × 10⁻⁵ |
| alcohol, and ethylene | | | | |
| glycol (4:1) | | | | |
| 20 wt % Cu and | | 934 | 106 | 9.9 × 10⁻⁵ |
| anhydrous alcohol | | | | |

Based on the above, the invention provides a conductive ink containing nano copper powders having a small particle size with copper isostearate as the precursor and containing a reducing agent a protective agent, wherein the copper isostearate is formed by the reduction reaction of isostearic acid and a copper-containing compound. Via the conductive ink of the invention, a conductive layer having a smaller thickness (such as 1 μm or less) and good conductivity can be formed, and advantages of simple preparation method (coating method) and low cost are obtained, so the current development trend of a compact and lightweight product is met.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

1. A conductive ink, comprising:
a precursor comprising copper isostearate (Cu(C₁₈H₃₆O₂)₂);
a reducing agent; and
a protective agent,
wherein based on a total weight of the conductive ink, a content of the precursor is 40 wt % to 75 wt %, a content of the reducing agent is 20 wt % to 32 wt %, and a content of the protective agent is 5 wt % to 40 wt %.

2. The conductive ink of claim 1, further comprising a solvent.

3. The conductive ink of claim 2, wherein the solvent comprises water, toluene, cyclohexane, n-heptane, isooctane, methanol (MeOH), ethanol (EtOH), ethylene glycol (EG), diethylene glycol, or supercritical carbon dioxide.

4. The conductive ink of claim 1, wherein the reducing agent comprises Vitamin C, sodium borohydride (NaBH₄), hydrazine (N₂H₄), hydrogen peroxide (H₂O₂), hydrogen (H₂), sodium hypophosphite (NaH₂PO₂), sodium citrate (Na₃C₆H₅O₇), potassium sodium tartrate (NaKC₄H₄O₆), an amine compound, or an aldehyde compound.

5. The conductive ink of claim 4, wherein the amine compound comprises dimethylformamide (DMF).

6. The conductive ink of claim 4, wherein the aldehyde compound comprises glucose.

7. The conductive ink of claim 1, wherein the protective agent comprises polyacrylic acid (PAA), polyvinyl alcohol (PVA), polyvinylpyrrolidone (PVP), gelatin, sodium dodecyl sulfate (SDS), polyethylene glycol octylphenyl ether (TX-100), cetyltrimethylammonium bromide (CTAB), sodium dioctyl sulfosuccinate (AOT), bis(2-ethylhexyl)phosphoric acid (HDEHP), oleic acid, or dodecaneamine.

8. The conductive ink of claim 1, wherein the precursor is formed by a reduction reaction of isostearic acid (C₁₈H₃₆O₂) and a copper-containing compound.

9. The conductive ink of claim 8, wherein the copper-containing compound comprises CuSO₄, CuCl₂, Cu(AOT)₂, Cu(NO₃)₂, Cu(OH)₂, or Cu(acac)₂.
